(19) United States
(12) Patent Application Publication
(10) Pub. No.: US 2005/0140294 A1
(43) Pub. Date: Jun. 30, 2005

(54) Cold cathode fluorescent lamp and method for forming the same

(75) Inventors: Ruey-Feng Jean, Taoyuan Hsien (TW); Jen-Chieh Yeh, Taoyuan Hsien (TW); Kuang-Lung Tsai, Taoyuan Hsien (TW); Shih-Hsien Lin, Taoyuan Hsien (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 11/020,123

(22) Filed: Dec. 27, 2004

(30) Foreign Application Priority Data
Dec. 26, 2003 (TW) 92137019

(51) Int. Cl. H01J 17/24; H01J 19/70; H01J 61/26; H01J 9/00

(52) U.S. Cl. 313/553; 313/559; 313/560; 445/29; 445/31

(57) ABSTRACT

A cold cathode fluorescent lamp. The cold cathode fluorescent lamp includes a transparent tube, at least one absorptive structure and at least one absorptive layer. The transparent tube is filled with a gas including a material capable of arousing light by means, of an electric potential. The absorptive structure is disposed on one end of the transparent tube and includes a supporting mechanism having at least one opening. The absorptive layer is formed in the opening and is not filled with the opening.

### BACKGROUND OF THE INVENTION

1. Field of the Invention

The present invention relates to a cold cathode fluorescent lamp (CCFL), and in particular to a cold cathode fluorescent lamp that excludes unnecessary gases or impurities therefrom, reduces operational potential thereof and prolongs lifespan thereof.

2. Description of the Related Art

A cold cathode fluorescent lamp (CCFL) generally has poor illumination and reduced lifespan when unnecessary gases or impurities exist therein. In the process of manufacturing the cold cathode fluorescent lamp, getter is employed to absorb the unnecessary gases or impurities existing in the glass tube thereof. The getter is then removed when the glass tube is sealed.

Referring to FIGS. 1A, 1B and 1C, an electrode 108 and a mercury-getter mixture alloy 102 are disposed in a glass tube 100. The electrode 108 includes a glass ball 106 and a metal wire 104. The mercury-getter mixture alloy 102 is separated from the metal wire 104 of the electrode 108 by a predetermined distance. The glass tube 100 has an opening 110 behind the mercury-getter mixture alloy 102 to connect an evacuating device. The glass tube 100 is evacuated and is filled with an inert gas. The glass tube 100 is then sealed to become a gastight chamber. The mercury-getter mixture alloy 102 is activated by high-frequency electromagnetic wave to release mercury particles into a light-emitting portion 112 of the glass tube 100. At this point, the getter material can absorb residual unnecessary gases or impurities. The glass ball 106 and glass tube 100 are then fused and the unnecessary part of the glass tube 100 and mercury-getter mixture alloy 102 behind a fusing portion 114 are removed.

Nevertheless, in the process of fusing the glass ball 106 and glass tube 100, additional unnecessary gases or impurities are generated. The additional unnecessary gases or impurities are remained in the glass tube 100 for increasing the operational potential thereof and reducing the lifespan thereof.

To solve the aforementioned problem, the getter is deployed in the glass tube to absorb the unnecessary gases or impurities. JP 8-339778, JP 2002-313277 and U.S. Pat. No. 5,572,088 disclose complicated structures to deploy the getter in the glass tubes thereof. Manufacture of the complicated structures, however, is difficult and the getter may be scattered over the entirety of the glass tubes by bombardment of ions therein.

Moreover, operation of the cold cathode fluorescent lamps in JP 2002-313277 and JP 7-45183 is changed to comply with structural design thereof, causing difficulty in lighting the cold cathode fluorescent lamps.

### SUMMARY OF THE INVENTION

Accordingly, an object of the invention is to provide a cold cathode fluorescent lamp. The cold cathode fluorescent lamp comprises a transparent tube and at least one absorptive structure. The transparent tube is filled with a gas comprising a material capable of arousing light by means of an electric potential. The absorptive structure is disposed on one end of the transparent tube and comprises a supporting mechanism having at least one opening, and at least one absorptive layer formed in the opening and not filled with the opening.

Another object of the invention is to provide a method of forming a cold cathode fluorescent lamp. The method comprises the steps of deploying at least one absorptive layer in an opening of a supporting mechanism, wherein the supporting mechanism and absorptive layer form a absorptive structure; disposing the absorptive structure in a transparent tube; evacuating the transparent tube; filling the transparent tube with a gas comprising a material capable of arousing light by means of an electric potential; and sealing the transparent tube such that the transparent tube and absorptive structure are tightly bonded.

Yet another object of the invention is to provide a absorptive structure. The absorptive structure comprises a supporting mechanism and at least one absorptive layer. The supporting mechanism has at least one opening. The absorptive layer is formed in the opening and is not filled with the opening.

The shape of the transparent tube is stripped, annular, curved, polygonal, or plated, and the material of the transparent tube is glass or transparent plastic.

The material of the absorptive layer is selected from the group consisting of zirconium, barium, vanadium, titanium, a zirconium-based alloy, a barium-based alloy, a vanadium-based alloy, a titanium-based alloy, and the mixture thereof, and the absorptive layer type is evaporative, non-evaporative or mixed.

The cold cathode fluorescent lamp further comprises at least one fusing mechanism disposed between the supporting mechanism and the transparent tube. The material of the fusing mechanism is capable of tightly bonding the supporting mechanism and transparent tube. The transparent tube is sealed by using a fusing mechanism to connect the supporting mechanism and transparent tube.

The cross section of the recess is circular, annular, rectangular, polygonal, regular, or irregular.

The method further comprises a step of forming at least one recess on the bottom of the opening of the supporting mechanism to receive the absorptive layer.

The method further comprises a step of forming at least one separating mechanism on the bottom of the opening of the supporting mechanism to form the recess.

The absorptive structure further comprises at least one connecting mechanism connected to the opposite side of the opening of the supporting mechanism. The connecting mechanism is connected to the supporting mechanism by integral forming as a single piece, fusing, welding, or embedding.

The supporting mechanism is cylindrical or cuplike, and the material of the supporting mechanism is selected from the group consisting of nickel, molybdenum, niobium, tungsten, a nickel-based alloy, a molybdenum-based alloy, a niobium-based alloy, a tungsten-based alloy, a carbon nanotube, a nickel-iron alloy, conductive plastic, and the mixture thereof.

The absorptive structure further comprises at least one recess formed on the bottom of the opening of the supporting mechanism. The material of the absorptive layer in one recess is identical to or different from that in the other recess when two or more recesses are formed.

To conclude, since the absorptive structure of the cold cathode fluorescent lamp of the invention is deployed with the absorptive layer, the unnecessary gases or impurities existing in the transparent tube can be absorbed at anytime by the absorptive layer. Thus, the unnecessary gases or impurities existing in the transparent tube are effectively reduced, illumination thereof is enhanced and lifespan thereof is prolonged.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A, 1B and 1C are schematic views of the process of manufacturing a conventional cold cathode fluorescent lamp;

FIG. 2 is a schematic partial view of the cold cathode fluorescent lamp of the first embodiment of the invention;

FIGS. 3A, 3B and 3C are schematic partial views of the absorptive structure of the second embodiment of the invention; and

FIGS. 4A and 4B are schematic partial views of the absorptive structure of the third embodiment of the invention.

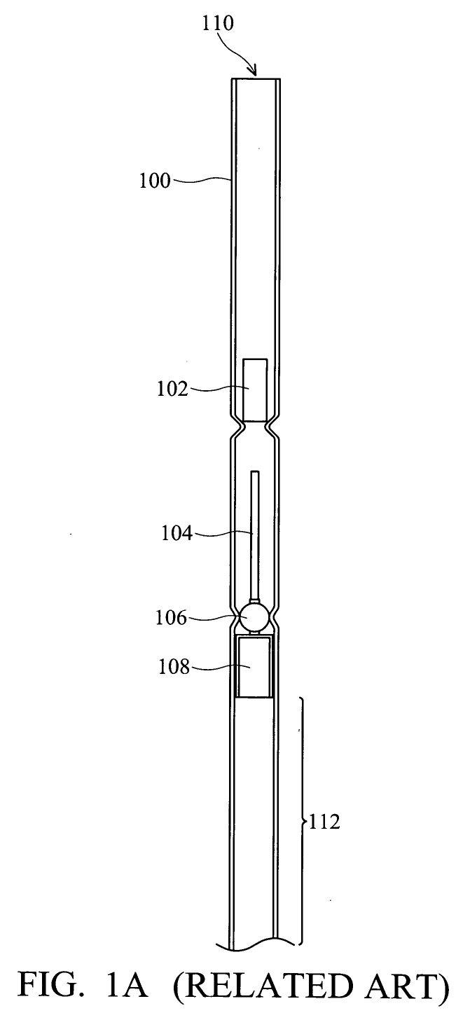

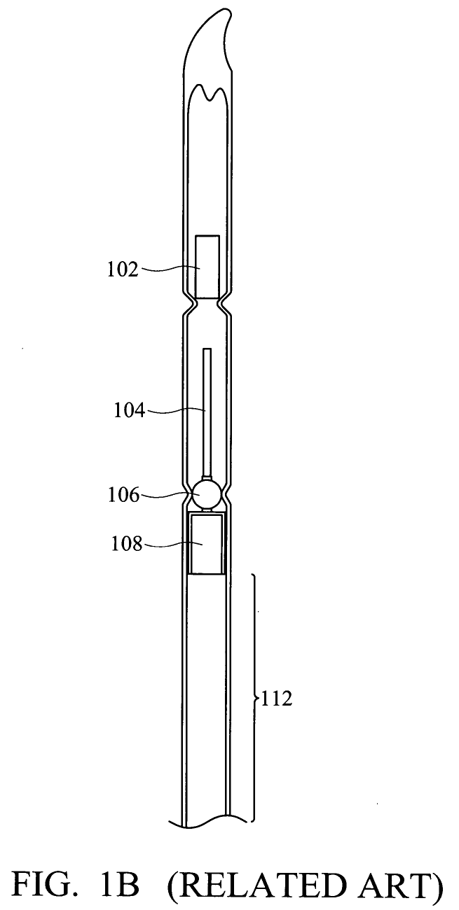

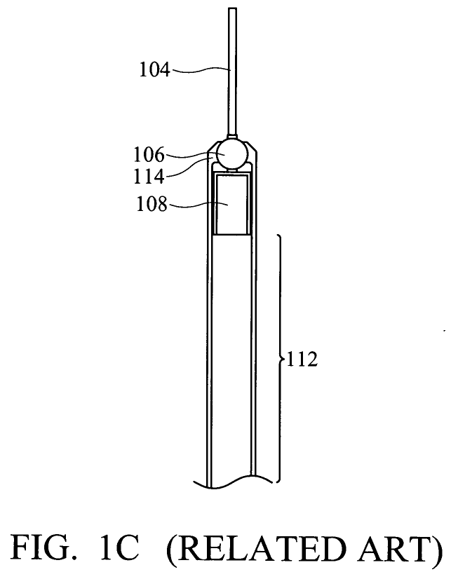

### DETAILED DESCRIPTION OF THE INVENTION

### First Embodiment

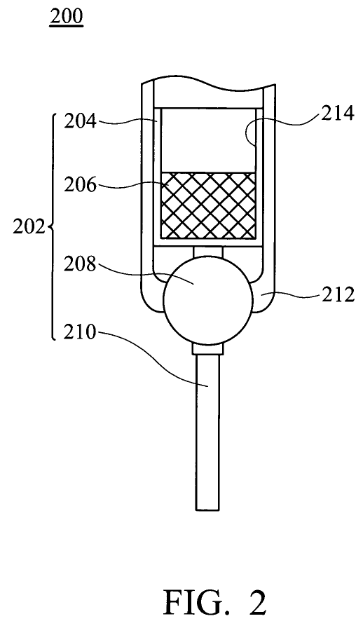

Referring to FIG. 2, the cold cathode fluorescent lamp 200 of this embodiment comprises a transparent tube 212 and an absorptive structure 202. The absorptive structure 202 further comprises a supporting mechanism 204 and an absorptive layer 206. The absorptive structure 202 may serve as getter. For example, the shape of the absorptive structure 202 is a cuplike shape.

The transparent tube 212 is closed and is filled with a gas capable of arousing light by means of an electric potential. The gas can be an inert gas, an inert gas with mercury particles, gaseous mercury, or a gas capable of arousing fluorescence. The material of the transparent tube 212 allows light therein to penetrate and diffuse and can be glass or transparent plastic. The shape of the transparent tube 212 can be stripped, annular, curved, polygonal, plated, regular, or irregular.

The supporting mechanism 204 is disposed on one end of the transparent tube 212 to support the absorptive layer 206 and to connect an external power source. The supporting mechanism 204 is a cylindrical or cuplike conductive mechanism and has an opening 214 whose shape is cylindrical or cuplike. A connecting mechanism 210 is connected to the opposite side of the opening 214 of the supporting mechanism 204 and extends therefrom, such that the external power source can be electrically connected to the supporting mechanism 204 via the connecting mechanism 210. The connecting mechanism 210 can be connected to the supporting mechanism 204 by integral forming as a single piece, fusing, welding, or embedding. The material of the supporting mechanism 204 and connecting mechanism 210 can be nickel, molybdenum, niobium, tungsten, a nickel-based alloy, a molybdenum-based alloy, a niobium-based alloy, a tungsten-based alloy, carbon nanotubes, a nickel-iron alloy, or conductive plastic. Specifically, the material of the supporting mechanism 204 can be identical to or different from that of the connecting mechanism 210. The height of the supporting mechanism 204 depends on the space near the end of the transparent tube 212. Preferably, the height of the supporting mechanism 204 is 2 to 6 mm.

The absorptive layer 206 can absorb the unnecessary gases or impurities existing in the transparent tube 212 and is disposed in the opening 214 of the supporting mechanism 204. The shape of the absorptive layer 206 depends on that of the opening 214. The absorptive layer 206 is bonded to the supporting mechanism 204 by filling, pressing, embedding, or evaporation deposition. The work function of the absorptive layer 206 is less than that of the supporting mechanism 204 and the material of the absorptive layer 206 can be zirconium, barium, vanadium, titanium, a zirconium-based alloy, a barium-based alloy, a vanadium-based alloy, or a titanium-based alloy. The thickness of the absorptive layer 206 is smaller than the depth of the opening 214. Preferably, the thickness of the absorptive layer 206 is approximately half the depth of the opening 214. At this point, the absorptive layer 206 can provide excellent absorption.

The absorptive layer 206 type can be evaporative, non-evaporative, or mixed. When the absorptive layer 206 is evaporative, the absorptive layer 206 is attached to the inner surface of the supporting mechanism 204 and an absorptive film with low work function and high activity is thereby formed during operation of the cold cathode fluorescent lamp 200. Accordingly, since the absorptive film has low work function, electrons can be easily aroused thereby. The operational potential of the cold cathode fluorescent lamp 200 is thus reduced. Additionally, since the absorptive film has high activity, it can easily react with and absorb the unnecessary gases or impurities in the transparent tube 212.

Moreover, since the work function of the compound from the absorptive layer 206 and unnecessary gases or impurities is less than that of the supporting mechanism 204, operational efficiency of the absorptive structure 202 is not reduced after the absorptive layer 206 absorbs the unnecessary gases or impurities.

Additionally, the absorptive structure 202 further comprises a fusing mechanism 208. The absorptive structure 202 is tightly bonded to the transparent tube 212 by means of the fusing mechanism 208. The material of the fusing mechanism 208 must be capable of being easily bonded to the absorptive structure 202 and transparent tube 212. For example, the fusing mechanism 208 is a glass ball. Accordingly, ineffective gastight bonding between the absorptive structure 202 and the transparent tube 212 can thereby be prevented.

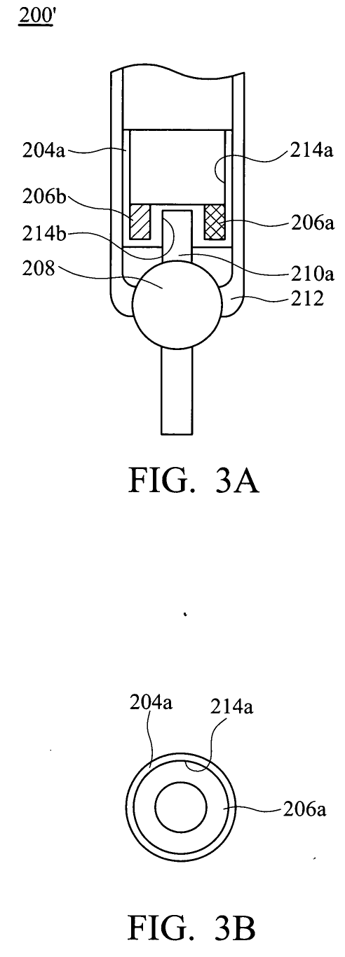

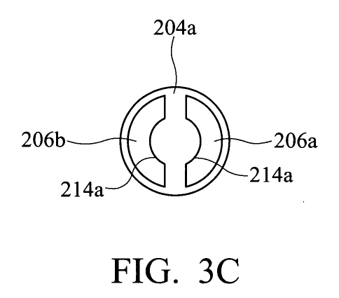

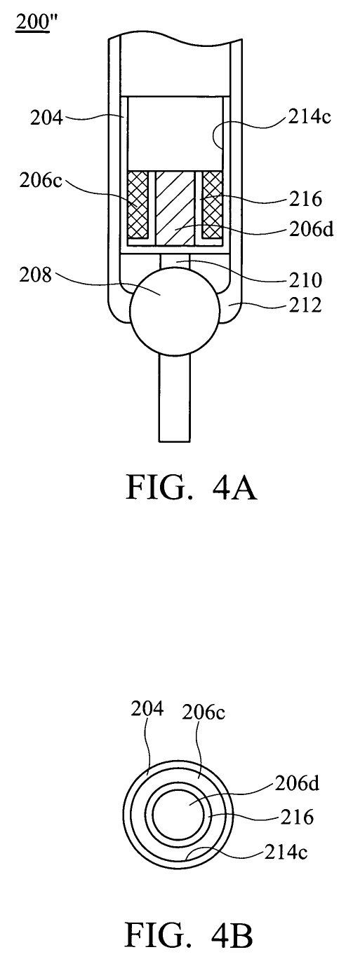

Furthermore, the supporting mechanism 204 of this embodiment is not limited to being cuplike and the absorptive layer 206 in the opening 214 is not limited to being cylindrical. Namely, the supporting mechanism 204 and opening 214 may have the shapes as shown in FIGS. 3A, 3B, 3C, 4A and 4B.

### Second Embodiment

Referring to FIGS. 3A, 3B and 3C, the cold cathode fluorescent lamp 200′ of this embodiment comprises a transparent tube 212 and a supporting mechanism 204a. The difference between this embodiment and the first embodiment is that the supporting mechanism 204a has a W shape. The supporting mechanism 204a comprises an opening 214a and an opening 214b. The opening 214a receives an absorptive layer 206a and an absorptive layer 206b while the opening 214b receives a connecting mechanism 210a. Specifically, the connecting mechanism 210a can be bonded to the opening 214b by embedding, engagement, or welding. The bottom of the opening 214a can be formed with a groove as shown in FIG. 3B or with recesses as shown in FIG. 3C. The depth of the groove or recesses is smaller than or equal to the maximum depth of the opening 214a. Preferably, the depth of the groove or recesses is half that of the opening 214a. The cross section of the groove or recesses on the bottom of the opening 214a can be annular, rectangular, polygonal, regular, or irregular. The absorptive layers 206a and 206b are deployed in the groove or recesses. The shapes of the absorptive layers 206a and 206b depend on the shape of the groove or recesses. Moreover, when the opening 214a has two or more recesses, the material of the absorptive layers 206a and 206b can be same or different.

### Third Embodiment

Referring to FIG. 4A and FIG. 4B, the cold cathode fluorescent lamp 200″ of this embodiment comprises a transparent tube 212 and a supporting mechanism 204b. The difference between this embodiment and the first embodiment is that a separating mechanism 216 is formed in the supporting mechanism 204b. Accordingly, multiple recesses are formed on the bottom of an opening 214c of the supporting mechanism 204b by the separating mechanism 216. The material of the separating mechanism 216 can be nickel, molybdenum, niobium, tungsten, a nickel based alloy, a molybdenum-based alloy, a niobium-based alloy, a tungsten-based alloy, carbon nanotubes, a nickel-iron alloy, or conductive plastic. The material of the separating mechanism 216 can be identical to or different from that of the supporting mechanism 204b. The separating mechanism 216 can be bonded to the supporting mechanism 204b by integral forming, embedding, engagement, welding, or fusing. The height of the separating mechanism 216 is smaller than or equal to the maximum height of the opening 214c. Preferably, the height of the separating mechanism 216 is half that of the opening 214c. The cross section of portions formed by the separating mechanism 216 can be circular, annular, rectangular, polygonal, regular, or irregular. Absorptive layers 206c and 206d are deployed in the portions. The shapes of the absorptive layers 206c and 206d depend on those of the portions. Additionally, the material of the absorptive layers 206a and 206b can be same or different.

The following description is directed to the process of manufacturing the cold cathode fluorescent lamp 200 of the first embodiment.

As shown in FIG. 2, the absorptive layer 206 is deployed in the supporting mechanism 204 to obtain the absorptive structure 202. The absorptive structure 202 is then disposed in the transparent tube 212. The transparent tube 212 is evacuated and the light-emitting portion thereof is filled with an inert gas or a gas (such as mercury gas) capable of arousing fluorescence. The transparent tube 212 is then sealed such that the transparent tube 212 and absorptive structure 202 are tightly bonded. At this point, the transparent tube 212 is tightly bonded to the supporting mechanism 204 or connecting mechanism 210 of the absorptive structure 202 and manufacture of the cold cathode fluorescent lamp 200 is complete.

To conclude, since the absorptive structure of the cold cathode fluorescent lamp of the invention is deployed with the absorptive layer, the unnecessary gases or impurities existing in the transparent tube can be absorbed at anytime by the absorptive layer. Thus, the unnecessary gases or impurities existing in the transparent tube are effectively reduced, illumination thereof is enhanced and lifespan thereof is prolonged.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art) Therefore, the scope of the appended claims should be accorded the broadest interpretation so as to encompass all such modifications and similar arrangements.

1. A cold cathode fluorescent lamp, comprising:
a transparent tube filled with a gas comprising a material capable of arousing light by means of an electric potential; and
at least one absorptive structure disposed on one end of the transparent tube and comprising a supporting mechanism having at least one opening, and
at least one absorptive layer formed in the opening and not filled with the opening.

2. The cold cathode fluorescent lamp as claimed in claim 1, further comprising at least one connecting mechanism connected to the opposite side of the opening of the supporting mechanism.

3. The cold cathode fluorescent lamp as claimed in claim 2, wherein the connecting mechanism is connected to the supporting mechanism by integrally forming, fusing, welding, or embedding.

4. The cold cathode fluorescent lamp as claimed in claim 1, wherein the material of the supporting mechanism is selected from the group consisting of nickel, molybdenum, niobium, tungsten, a nickel-based alloy, a molybdenum-based alloy, a niobium-based alloy, a tungsten-based alloy, a carbon nanotube, a nickel-iron alloy, conductive plastic, and the mixture thereof.

5. The cold cathode fluorescent lamp as claimed in claim 1, wherein the shape of the transparent tube is stripped, annular, curved, polygonal, or plated, and the material of the transparent tube is glass or transparent plastic.

6. The cold cathode fluorescent lamp as claimed in claim 1, wherein the material of the absorptive layer is selected from the group consisting of zirconium, barium, vanadium, titanium, a zirconium-based alloy, a barium-based alloy, a vanadium-based alloy, a titanium-based alloy, and the mixture thereof, and the absorptive layer type is evaporative, non-evaporative or mixed.

7. The cold cathode fluorescent lamp as claimed in claim 1, further comprising at least one fusing mechanism disposed between the supporting mechanism and the transparent tube.

8. The cold cathode fluorescent lamp as claimed in claim 7, wherein the material of the fusing mechanism is capable of tightly bonding the supporting mechanism and transparent tube.

9. The cold cathode fluorescent lamp as claimed in claim 1, further comprising at least one recess formed on the bottom of the opening of the supporting mechanism, wherein the material of the absorptive layer in one recess is identical to or different from that in the other recess when two or more recesses are formed.

10. The cold cathode fluorescent lamp as claimed in claim 9, wherein the cross section of the recess is circular, annular, rectangular, polygonal, regular, or irregular.

11. A method of forming a cold cathode fluorescent lamp, comprising the steps of:
deploying at least one absorptive layer in an opening of a supporting mechanism, wherein the supporting mechanism and absorptive layer form a absorptive structure;
disposing the absorptive structure in a transparent tube;
evacuating the transparent tube;
filling the transparent tube with a gas comprising a material capable of arousing light by means of an electric potential; and
sealing the transparent tube such that the transparent tube and absorptive structure are tightly bonded.

12. The method as claimed in claim 11, wherein a connecting mechanism is connected to the opposite side of the opening of the supporting mechanism.

13. The method as claimed in claim 11, wherein the transparent tube is sealed by using a fusing mechanism to connect the supporting mechanism and transparent tube.

14. The method as claimed in claim 11, further comprising a step of forming at least one recess on the bottom of the opening of the supporting mechanism to receive the absorptive layer.

15. The method as claimed in claim 14, further comprising a step of forming at least one separating mechanism on the bottom of the opening of the supporting mechanism to form the recess.

16. An absorptive structure, comprising:
a supporting mechanism, with at least one opening; and
at least one absorptive layer formed in the opening and not filled with the opening.

17. The absorptive structure as claimed in claim 16, further comprising at least one connecting mechanism connected to the opposite side of the opening of the supporting mechanism.

18. The absorptive structure as claimed in claim 16, wherein the supporting mechanism is cylindrical or cuplike, and the material of the supporting mechanism is selected from the group consisting of nickel, molybdenum, niobium, tungsten, a nickel-based alloy, a molybdenum-based alloy, a niobium-based alloy, a tungsten-based alloy, a carbon nanotube, a nickel-iron alloy, conductive plastic, and the mixture thereof.

19. The absorptive structure as claimed in claim 16, wherein the material of the absorptive layer is selected from the group consisting of zirconium, barium, vanadium, titanium, a zirconium-based alloy, a barium-based alloy, a vanadium-based alloy, a titanium-based alloy, and the mixture thereof, and the absorptive layer type is evaporative, non-evaporative or mixed.

20. The absorptive structure as claimed in claim 16, further comprising at least one recess formed on the bottom of the opening of the supporting mechanism, wherein the material of the absorptive layer in one recess is identical to or different from that in the other recess when two or more recesses are formed.
